(19) United States
(12) Patent Application Publication
(10) Pub. No.: US 2013/0046472 A1
(43) Pub. Date: Feb. 21, 2013

(54) METHOD OF DETERMINING THE RELATIVE POSITION OF TWO DETECTORS AT THE BOTTOM OF THE SEA

(71) Applicant: Juan Cantillo, Courbevoie (FR)

(72) Inventor: Juan Cantillo, Courbevoie (FR)

(73) Assignee: TOTAL SA, Courbevoie (FR)

(21) Appl. No.: 13/640,013

(22) PCT Filed: Mar. 25, 2011
(86) PCT No.: PCT/FR2011/050659

§ 371 Date: Oct. 8, 2012

(30) Foreign Application Priority Data
Apr. 6, 2010 (FR) 10 52598

(51) Int. Cl. G01V 3/38; G06F 15/00

(52) U.S. Cl. 702/5; 702/150

(57) ABSTRACT

A method of determining the relative position of two detectors at the bottom of the sea by emitting N waves from a first set of N emission points, and recording for each point of emission of the first set the propagation time of the wave between said emission point and a first detector R1. Next, emitting Q waves from a second set of Q emission points, and recording for each emission point of the second set the propagation time of the wave between the emission point and a second detector R2. Relative position of the two detectors R1 and R2 can then be determined.

### PRIORITY CLAIM

The present application is a National Phase entry of PCT Application No. PCT/FR2011/050659, filed Mar. 25, 2011, which claims priority from French Application Number 10 52598, filed Apr. 6, 2010, the disclosures of which are hereby incorporated by reference herein in their entirety.

### FIELD OF THE INVENTION

The invention relates to subsurface exploration techniques, and in particular to a method of determining the relative position of two detectors placed under the sea, in particular on the surface of the seabed.

### BACKGROUND OF THE INVENTION

It is known, particularly in oil exploration, to produce seismic images from a series of geophysical measurements conducted from the surface of a subsoil region. In the seismic technique, these measurements involve emitting a wave into the subsoil and measuring a signal containing reflections of the wave on the geological structures encountered. These structures are typically the surfaces separating different materials or faults.

Seismic images are representations of the subsoil in two or three dimensions, with the vertical dimension corresponding either to the propagation times of the seismic waves, or to the depths. They are obtained by techniques which use a model of estimated velocity providing a map of the seismic wave propagation speed in the rocks constituting the area being explored. This velocity model is used to estimate the positions of the reflectors in the subsoil based on seismic recordings. The seismic images produced in this way have some distortions of course, as do the underlying velocity models, because these are only estimates derived from a necessarily limited number of measurements.

In the case of marine subsurface exploration, seismic wave detectors can be placed at the bottom of the sea on the subsoil to be explored. Seismic waves are emitted from the ocean surface. These waves propagate in the water and enter the subsoil. The detectors placed on the seabed on the surface of the subsoil will detect the arrival of the direct seismic wave as well as the waves reflected by the subsoil.

In order to monitor the evolution of a subsurface oil reservoir, it is possible to obtain a first seismic image of the subsoil at a given moment then obtain a second seismic image of the same subsoil after a certain amount of time.

In particular, to track the changes in hydrocarbon content of a reservoir in production, it can be useful to monitor the evolution of the seismic image of the subsoil over time.

In order to be able to compare two seismic images of the same subsoil captured at different times, it is important to know how to reposition each detector on the surface of the subsoil as accurately as possible.

The detectors are generally positioned at the bottom of the sea at a depth of several hundred meters using a Remotely Operated Vehicle (ROV) controlled from the surface. However, the operating constraints on deploying such vehicles combined with the accuracy of their onboard acoustic positioning systems, which require long stabilization and calibration times, commonly lead to inaccurate positioning of the receiver relative to the planned position.

Generally, the position of the detector is only known to a precision of about 10 meters.

In this context where sets of measurements are collected at different times, this implies an uncertainty of 20 m in the position of the detector, which considerably reduces the repeatability of the measurements.

In order to compare data in sets of measurements collected at different times, it is important to be able to determine the differences between the detector positions when the first set of measurements is collected and the detector positions when the second set of measurements is collected.

A need therefore exists for a means of determining the relative position of two detectors placed underwater, in particular at the bottom of the sea. It is sufficient for this method to determine the position in a plane, because it is known that the detectors are placed on the surface of the seabed.

### SUMMARY OF THE INVENTION

The invention proposes a method of determining the relative position of a first detector R1 and of a second detector R2 which are placed under the sea, comprising the steps of:
emitting N waves from a first set of N emission points,
recording for each emission point in said first set the propagation time of said wave between said emission point and the first detector R1,
emitting Q waves from a second set of Q emission points,
recording for each emission point in said second set the propagation time of said wave between said emission point and the second detector R2,
determining the relative position of the two detectors R1 and R2 by using the following equation:

$$\vert {t}_{1} - {t}_{2} \vert = \frac{\vec{u} . ( \vec{{S}_{1} {S}_{2}} - \vec{{R}_{1} {R}_{2}} )}{V} ,$$

where \vec{S₁S₂} is the vector from the position of a first emission point S1 chosen

from the first set of N emission points to a second emission point S2 chosen from the second set of Q emission points,
\vec{R₁R₂} is the vector from the position of the first detector R1 to the position of the second detector R2,
\vec{u} is the unit vector from the center of the segment formed by the two detectors R1 and R2 to the center of the segment formed by the two emission points S1 and S2,
t₁ is the wave propagation time from the first emission point S1 to the first detector R2,
t₂ is the wave propagation time from the second emission point S2 to the second detector R2, and
V is the propagation speed of the wave in the sea.

Advantageously, the method of the invention allows determining the relative positions of at least two detectors placed on the surface of the seabed, whether these detectors are placed on the surface of the seabed at the same time or at different times. Thus the method of the invention can be used to evaluate repeatability between at least two sets of collected measurements. In addition, the method of the invention can be used to evaluate the position of at least one detector placed on the surface of a seabed relative to a reference detector which has a position on the surface of the seabed that is known to a high level of accuracy.

A method of the invention may further comprise one or more of the following optional features, individually or in any possible combination:
the first set of N emission points and the second set of Q emission points are identical,
the first emission point S1 and the second emission point S2 are the same,
the first detector R1 and the second detector R2 are placed under the sea at different times,
the wave emitted from each emission point is a pressure wave, and
the method further comprises, prior to the step of determining the relative position of the two detectors R1 and R2, the following steps for determining the position of at least one of the detectors R1 or R2:
   determining P time intervals Tᵢ where P>1 such that, for each time interval Tᵢ, there exist Mᵢ emission points, Mᵢ>3 for 1<i<P, among the emission points of one of the sets of emission points, said emission points Mᵢ having propagation times that lie in said time interval Tᵢ,
determining for each time interval Tᵢ the circle which passes closest to the Mᵢ points whose propagation time lies in said time interval Tᵢ,
determining the position of said detector R1 or R2 as being at the bottom of the sea, vertically aligned with the barycenter of the P centers of the previously determined circles.

The invention also relates to a method of determining relative positions of a set of detectors placed under the sea, wherein the position of each detector is determined by a method according to the invention, using a reference detector of known position.

The invention also relates to a method of evaluating repeatability of detector placement under the sea, comprising the steps of:
sampling the surface of the subsoil to be mapped at K measurement points,
placing a wave detector in the vicinity of each measurement point,
determining for each detector the wave emitted from each emission point and the waves reflected by the subsoil,

noteworthy in that the above steps are repeated at two or more different times and the relative positions of the detectors each time are determined by a method according to the invention.

The invention also relates to a method of mapping marine subsoil, comprising the steps of:
sampling the surface of the subsoil to be mapped at K measurement points,
placing a wave detector in the vicinity of each measurement point,
determining the absolute position of at least one reference detector,
determining the position of each detector relative to the reference detector by using a method according to the invention, and
determining for each detector the wave emitted from each emission point and the waves reflected by the subsoil.

The invention also relates to a method of monitoring evolution over time of marine subsoil, wherein the mapping method of the invention is repeated at two or more different times and the obtained maps are compared.

### BRIEF DESCRIPTION OF THE DRAWINGS

The invention will be better understood by reading the following description, provided solely as an example, and by referring to the attached drawings in which:

FIG. 1 illustrates the different steps of a method according to an embodiment of the invention,

FIG. 2 illustrates the sampling from the ocean surface with N emission points, and

FIG. 3 illustrates the determination of the relative position of a first detector and a second detector according to the invention.

For clarity, the various elements represented in the figures are not necessarily to scale.

### DESCRIPTION OF EMBODIMENTS

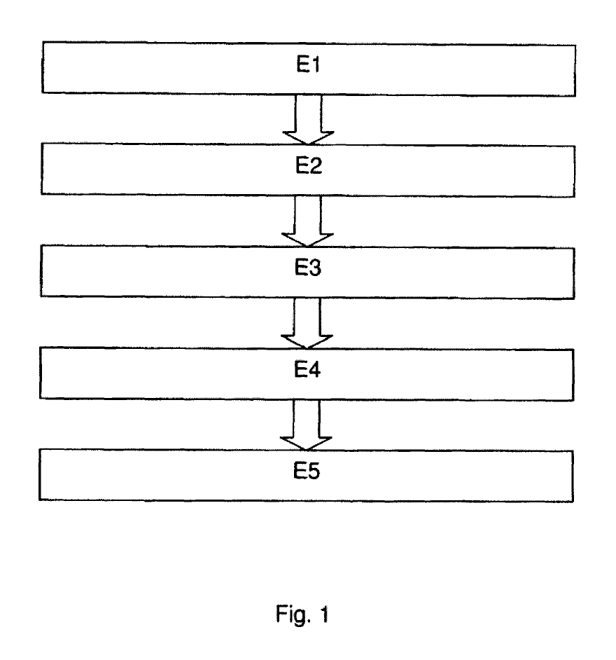

As represented in FIG. 1, a method according to the invention for determining the relative position of a first detector R1 and a second detector R2 placed under the sea may comprise:
a step E1 of emitting N waves from a first set of N emission points,
a step E2 of recording for each emission point in said first set the propagation time of said wave between said emission point and the first detector R1,
a step E3 of emitting Q waves from a second set of Q emission points,
a step E4 of recording for each emission point in said second set the propagation time of said wave between said emission point and the second detector R2, and
a step E5 of determining the relative position of the two detectors R1 and R2.

In one embodiment, the method of the invention may be carried out as part of a method of monitoring the evolution of marine subsoil.

In the context of a method of monitoring the evolution of marine subsoil, the subsoil is sampled at K measurement points. The area to be mapped may, for example, be substantially square and have dimensions of 5 km per side. The sampling of the marine subsoil may consist of positioning measurement points approximately 200 meters apart from each other.

A person skilled in the art can adapt the distances between measurement points according to predefined operating objectives.

When collecting a first set of measurements, a seismic wave detector is positioned at each measurement point. Each detector is positioned using a remotely operated vehicle (ROV). As indicated above, in this context it is generally difficult and costly to determine the position of the detector accurately when it is placed using an ROV.

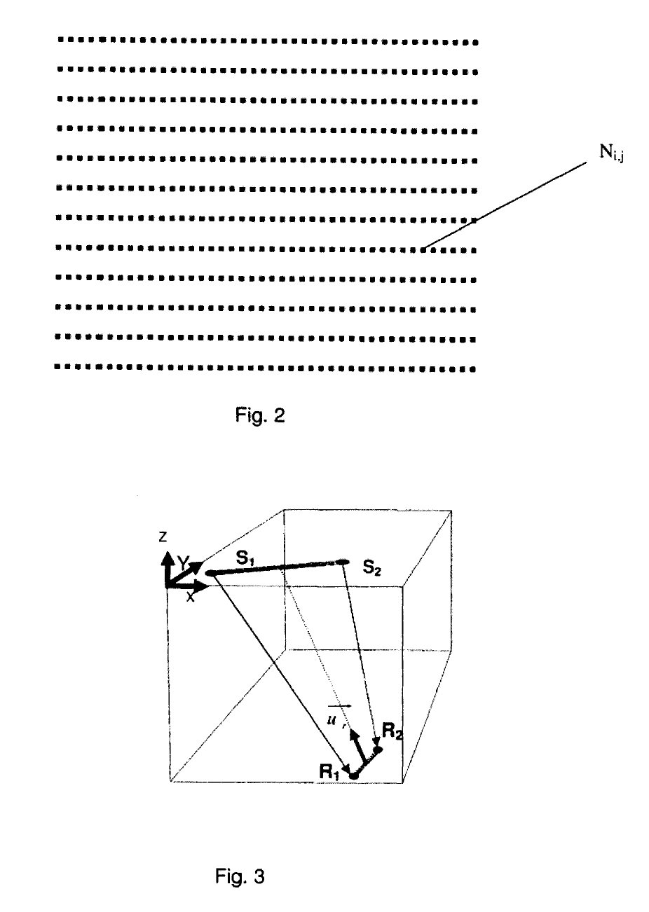

As illustrated in FIG. 2, in one embodiment the ocean surface sampling is done at N emission points. At each emission point, a wave is emitted and the propagation time for each wave between the emission point and each detector is recorded.

In one embodiment, a ship travels the surface of the ocean in the vicinity of the devices while emitting seismic waves at regular intervals of time. The coordinates of each emission point are determined based on the known coordinates of the ship at the moment the seismic waves are emitted, called the “shot”.

For each emission point, the propagation time for the seismic wave between the emission point and each detector placed on the surface of the marine subsoil is recorded.

When collecting the second set of measurements, a seismic wave detector is repositioned at each measurement point. Each detector is repositioned using an ROV controlled from the surface.

Sampling is done at the sea surface at Q emission points. At each emission point, a wave is emitted and the propagation time for each wave between the emission point and each detector is recorded.

For each emission point, the propagation time of the seismic wave between the emission point and each detector placed on the surface of the marine subsoil is recorded.

In order to evaluate the repeatability of the positioning of the detectors on the marine subsoil for each of the K subsoil sampling points, the relative position of the detector placed in the vicinity of a point during the first set of measurements is determined relative to the position of a detector placed in the vicinity of this same point during the second set of measurements.

As illustrated in FIG. 2, determining the relative position of the two detectors R1 and R2 is done using the following equation:

$$\vert {t}_{1} - {t}_{2} \vert = \frac{\vec{u} . ( \vec{{S}_{1} {S}_{2}} - \vec{{R}_{1} {R}_{2}} )}{V} ,$$

where \vec{S₁S₂} is the vector connecting the position of a first emission point S1 chosen from

the first set of N emission points and a second emission point S2 chosen from the second set of Q emission points,

\vec{R₁R₂} is the vector connecting the position of the first detector R1 and the position of the second detector R2,

\vec{u} is the unit vector from the center of the segment formed by the two detectors R1 and R2 to the center of the segment formed by the two emission points S1 and S2,

t₁ is the wave propagation time from the first emission point S1 to the second detector R1,

t₂ is the wave propagation time from the second emission point S2 to the second detector R2, and

V is the propagation speed of the wave in the sea.

In one embodiment of the invention, it is possible to determine the relative positions of at least two detectors by using a known function of |t₁−t₂|, or any other measurement which when known allows obtaining that of |t₁₋ₜ₂|.

In one embodiment of the invention, the method of the invention may be used to determine the relative position of at least two detectors placed simultaneously on the surface of a seabed.

In this case, the first and second sets of emission points can be merged. In addition, the sources S₁ and S₂ can also be the merged. This advantageously simplifies the implementation of the method of the invention.

In one embodiment, the method of the invention may take place as part of a process of mapping a marine subsoil. For example, the method of the invention can be used to determine the relative positions of a set of detectors positioned on the surface of a marine subsoil relative to a reference detector whose position is known to a high level of accuracy.

In the context of a method of mapping a marine subsoil, the subsoil is sampled at K measurement points.

A reference detector is positioned on the surface of the marine subsoil. The position of the reference detector is determined to a high level of accuracy.

A seismic wave detector is positioned at each measurement point. Each detector is positioned using an ROV.

The relative position of each detector in relation to the reference detector is determined by a method of the invention.

In one embodiment of the invention, the reference detector may be chosen from among the set of detectors placed on the surface of the seabed.

In one embodiment of the invention, the reference detector can be attached to the surface of the subsoil to be mapped. The position of the reference detector can be redetermined in each set of mapping measurements. This advantageously allows estimating the movements in the marine subsoil.

In one embodiment of the invention, the accurately determined position of the reference detector as mentioned above may be determined by means of the following steps:
determining P time intervals Tᵢ where P>1 such that, for each time interval Tᵢ, there exist Mᵢ emission points, Mᵢ>3 for 1<i<P, among the emission points of one of the sets of emission points, said emission points Mᵢ having propagation times that lie in said time interval Tᵢ,
determining for each time interval Ti the circle which passes closest to the Mᵢ points whose propagation time lies in said time interval Tᵢ,
determining said precise position of said reference detector as being at the bottom of the sea, vertically aligned with the barycenter of the P centers of the previously determined circles.

In one embodiment, the step of determining a time interval Tᵢ[T_{i,1}, T_{i,2}] for a detector can be done by setting a first time, for example T_{i,1}, and determining the second time T_{i,2} of the interval such that there exist at least 3 emission points for which the propagation times are between T_{i,1} and T_{i,2}.

In one embodiment of the invention, the time interval is determined such that there exist at least 3 emission points for which the propagation times are between T_{i,1} and T_{i,2}, and the maximum angular displacement between two consecutive points of this set of points and the assumed position of the receiver are less than or equal to 120° .

The invention is not limited to the embodiments described, and is to be interpreted in a non-limiting manner to include any equivalent embodiment. In particular, the position of the reference detector may be determined by any means known to a person skilled in the art.

1-10. (canceled)

11. A method of determining the relative position of a first detector R1 and of a second detector R2, the detectors being placed under the sea, the method comprising the steps of:
emitting N waves from a first set of N emission points, where N is an integer greater than 2,
recording for each emission point in said first set the propagation time of said wave between said emission point and the first detector R1,
emitting Q waves from a second set of Q emission points, where Q is an integer greater than 2,
recording for each emission point in said second set the propagation time of said wave between said emission point and the second detector R2, and
determining the relative position of the two detectors R1 and R2 by using the following equation:
$$\vert {t}_{1} - {t}_{2} \vert = \frac{\vec{u} . ( \vec{{S}_{1} {S}_{2}} - \vec{{R}_{1} {R}_{2}} )}{V} ,$$
where \vec{S₁S₂} is the vector from the position of a first emission point S1 chosen from the first set of N emission points to a second emission point S2 chosen from the second set of Q emission points,
\vec{R₁R₂} is the vector from the position of the first detector R1 to the position of the second detector R2,
\vec{u} is the unit vector from the center of the segment formed by the two detectors R1 and R2 to the center of the segment formed by the two emission points S1 and S2,
t₁ is the wave propagation time from the first emission point S1 to the first detector R1,
t₂ is the wave propagation time from the second emission point S2 to the second detector R2, and
V is the propagation speed of the wave in the sea.

12. The method according to claim 11, wherein the first set of N emission points and the second set of Q emission points are identical.

13. The method according to claim 12, wherein the first emission point S1 and the second emission point S2 are the same.

14. The method according to claim 11, wherein the first detector R1 and the second detector R2 are placed under the sea at different times.

15. The method according to claim 11, wherein the wave emitted from each emission point is a pressure wave.

16. The method according to claim 11, further comprising, prior to the step of determining the relative position of the two detectors R1 and R2, the following steps for determining the position of at least one of the detectors R1 or R2:
determining P time intervals Tᵢ where P>1 such that, for each time interval Tᵢ, there exist, among the emission points of one of the sets of emission points, Mᵢ emission points, Mᵢ>3 for 1<i<P, said emission points Mᵢ having propagation times that lie in said time interval T_{i.}
determining for each time interval Tᵢ a circle which passes closest to the Mᵢ points having propagation time in said time interval Tᵢ,
determining the position of said detector R1 or R2 as being at the bottom of the sea, vertically aligned with the barycenter of the P centers of the previously determined circles.

17. A method of determining relative positions of a set of detectors placed under the sea, the method comprising using a reference detector R1 of known position among the set of detectors and, for each other detector R2 of the set:
emitting N waves from a first set of N emission points, where N is an integer greater than 2,
recording for each emission point in said first set the propagation time of said wave between said emission point and the reference detector R1,
emitting Q waves from a second set of Q emission points, where Q is an integer greater than 2,
recording for each emission point in said second set the propagation time of said wave between said emission point and said other detector R2, and
determining the relative position of the two detectors R1 and R2 by using the following equation:
$$\vert {t}_{1} - {t}_{2} \vert = \frac{\vec{u} . ( \vec{{S}_{1} {S}_{2}} - \vec{{R}_{1} {R}_{2}} )}{V} ,$$
where \vec{S₁S₂} is the vector from the position of a first emission point S1 chosen from the first set of N emission points to a second emission point S2 chosen from the second set of Q emission points,
\vec{R₁R₂} is the vector from the position of the reference detector R1 to the position of said other detector R2,
\vec{u} is the unit vector from the center of the segment formed by the reference detector R1 and said other R2 to the center of the segment formed by the two emission points S1 and S2,
t₁ is the wave propagation time from the first emission point S1 to the reference detector R1,
t₂ is the wave propagation time from the second emission point S2 to said other detector R2, and
V is the propagation speed of the wave in the sea.

18. A method of evaluating repeatability of detector placement under the sea, comprising the steps of:
sampling the surface of the subsoil to be mapped at K measurement points,
placing a wave detector in the vicinity of each measurement point,
determining relative positions of the detectors, wherein determining the relative position of a first detector R1 and of a second detector R2 comprises:
emitting N waves from a first set of N emission points, where N is an integer greater than 2;
recording for each emission point in said first set the propagation time of said wave between said emission point and the first detector RI;
emitting Q waves from a second set of Q emission points, where Q is an integer greater than 2;
recording for each emission point in said second set the propagation time of said wave between said emission point and the second detector R2; and
determining the relative position of the two detectors R1 and R2 by using the following equation:
$$\vert {t}_{1} - {t}_{2} \vert = \frac{\vec{u} . ( \vec{{S}_{1} {S}_{2}} - \vec{{R}_{1} {R}_{2}} )}{V} ,$$
where \vec{S₁S₂} is the vector from the position of a first emission point S1 chosen from the first set of N emission points to a second emission point S2 chosen from the second set of Q emission points,
\vec{R₁R₂} is the vector from the position of the first detector R1 to the position of the second detector R2,
\vec{u} is the unit vector from the center of the segment formed by the two detectors R1 and R2 to the center of the segment formed by the two emission points S1 and S2,
t₁ is the wave propagation time from the first emission point S1 to the first detector R1,
t₂ is the wave propagation time from the second emission point S2 to the second detector R2, and
V is the propagation speed of the wave in the sea, and
determining for each detector the wave emitted from each emission point and the waves reflected by the subsoil,
wherein said steps are repeated at two or more different times.

19. A method of mapping marine subsoil, comprising the steps of:
sampling the surface of the subsoil to be mapped at K measurement points,
placing a wave detector in the vicinity of each measurement point,
determining the absolute position of at least one reference detector R1,
determining the position of another detector R2 relative to the reference detector,
determining for each detector the wave emitted from each emission point and the waves reflected by the subsoil,
wherein determining the position of the other detector relative to the reference detector comprises:
emitting N waves from a first set of N emission points, where N is an integer greater than 2,
recording for each emission point in said first set the propagation time of said wave between said emission point and the reference detector R1,
emitting Q waves from a second set of Q emission points, where Q is an integer greater than 2,
recording for each emission point in said second set the propagation time of said wave between said emission point and said other detector R2, and
determining the relative position of the two detectors R1 and R2 by using the following equation:
$$\vert {t}_{1} - {t}_{2} \vert = \frac{\vec{u} . ( \vec{{S}_{1} {S}_{2}} - \vec{{R}_{1} {R}_{2}} )}{V} ,$$
where \vec{S₁S₂} is the vector from the position of a first emission point Si chosen from the first set of N emission points to a second emission point S2 chosen from the second set of Q emission points,
\vec{R₁R₂} is the vector from the position of the reference detector R1 to the position of said other detector R2,
\vec{u} is the unit vector from the center of the segment formed by the reference detector R1 and said other R2 to the center of the segment formed by the two emission points S1 and S2,
t₁ is the wave propagation time from the first emission point Si to the reference detector R1,
t₂ is the wave propagation time from the second emission point S2 to said other detector R2, and
V is the propagation speed of the wave in the sea.

20. A method of monitoring evolution over time of marine subsoil, the method of monitoring comprising repeating a mapping method at two or more different times and comparing the obtained maps, wherein the mapping method comprises: e
sampling the surface of the subsoil to be mapped at K measurement points,
placing a wave detector in the vicinity of each measurement point,
determining the absolute position of at least one reference detector R1,
determining the position of another detector R2 relative to the reference detector,
determining for each detector the wave emitted from each emission point and the waves reflected by the subsoil,
wherein determining the position of the other detector relative to the reference detector comprises:
emitting N waves from a first set of N emission points, where N is an integer greater than 2,
recording for each emission point in said first set the propagation time of said wave between said emission point and the reference detector R1,
emitting Q waves from a second set of Q emission points, where Q is an integer greater than 2,
recording for each emission point in said second set the propagation time of said wave between said emission point and said other detector R2, and
determining the relative position of the two detectors R1 and R2 by using the following equation:
$$\vert {t}_{1} - {t}_{2} \vert = \frac{\vec{u} . ( \vec{{S}_{1} {S}_{2}} - \vec{{R}_{1} {R}_{2}} )}{V} ,$$
where \vec{S₁S₂} is the vector from the position of a first emission point Si chosen from the first set of N emission points to a second emission point S2 chosen from the second set of Q emission points,
\vec{R₁R₂} is the vector from the position of the reference detector R1 to the position of said other detector R2,
\vec{u} is the unit vector from the center of the segment formed by the reference detector R1 and said other R2 to the center of the segment formed by the two emission points S1 and S2,
t₁ is the wave propagation time from the first emission point S1 to the reference detector R1,
t₂ is the wave propagation time from the second emission point S2 to said other detector R2, and
V is the propagation speed of the wave in the sea.
